(19) United States
(12) Patent Application Publication
(10) Pub. No.: US 2009/0159153 A1
(43) Pub. Date: Jun. 25, 2009

(54) LABORATORY INSTRUMENT WITH A DOSAGE MATERIAL FUNNELING DEVICE

(75) Inventor: Paul Luechinger, Uster (CH)

Correspondence Address: STANDLEY LAW GROUP LLP, 6300 Riverside Drive, Dublin, OH, 43017, US

(73) Assignee: Mettler-Toledo AG, Greifensee (CH)

(21) Appl. No.: 12/273,942

(22) Filed: Nov. 19, 2008

(30) Foreign Application Priority Data
Dec. 19, 2007 (EP) 07123572.5

(51) Int. Cl. B67C 11/04

(52) U.S. Cl. 141/331; 422/99

(57) ABSTRACT

A laboratory instrument with a dosage-dispensing device for the delivery of measured doses of a dosage material in the form of a powder, paste or granulate into at least one target container is equipped with dosage material funneling device which is arranged between an outlet opening of the dosage-dispensing device and the target container. The dosage material funneling device includes an agitating means and at least one funnel holder arranged on the agitating means, wherein the funnel holder serves to receive an exchangeable funnel which in its installed condition in the laboratory instrument, when the latter is ready for operation, presents a profile which decreases in width in the direction of gravity.

### CROSS-REFERENCE TO RELATED APPLICATIONS

This application is entitled to, and claims, benefit of a right of priority under 35 USC §119 from European patent application 07 12 3572.5, filed 19 Dec. 2007, the content of which is incorporated by reference as if fully recited herein.

### TECHNICAL FIELD

The invention relates to a laboratory instrument with a dosage-dispensing device serving to deliver measured doses of powders, pastes or granulates into a target container.

### BACKGROUND OF THE ART

Laboratory instruments with dosage-dispensing devices of the aforementioned kind find application in particular for the dispensing of small quantities of, e.g., toxic substances with high precision into target containers. In many cases, such target containers are set on a balance which serves to weigh the substance quantity delivered by the dosage-dispensing device, so that it can subsequently be processed further in accordance with a set purpose.

The substance to be measured out, for example the dosage material to be dispensed, is contained for example in a source container which is equipped with a dispensing head. It is desirable to discharge the dosage material through a small opening of the dosage-dispensing device, so that it can be filled in a targeted stream into a container with a narrow fill opening.

Instruments with dosage-dispensing devices for pulverous bulk materials, for example for pigments in powder form, belong to the known state of the art and are in practical use. As an example, a dosage-dispensing device is described in U.S. Pat. No. 5,145,009 A, which consists of a source container with a closable outlet at its underside. The function of a closure element is performed by a cone-shaped valve body whose diameter decreases in the upward direction, which can be moved vertically downward in order to open an outlet opening, which rotates while in its open position and is equipped with means for advancing the material in the direction of the outlet opening. The source container is further traversed by a drive shaft which protrudes from the top of the source container and is coupled above the latter to a drive mechanism. During the dosage-dispensing operation, the target container to be filled rests on a balance whose weighing signal is transmitted to a processor unit in the drive mechanism of the closure element. Based on the continuous measurement of the quantity of the dispensed substance by means of a balance, the closure element can be shut at the right moment of reaching the target weight.

The device of the foregoing description is less suitable for the dispensing of bulk material into containers with a narrow fill aperture. The upward-narrowing profile of the valve body as well as its rotary movement impart a radial, i.e. horizontal velocity component to the substance particles at the outlet opening and therefore cause a scattering of the particles which can reach beyond even a relatively large opening of a container to be filled.

However, there are technical reasons why the width of the outlet opening cannot be reduced without limit in order to be able to dispense substances even into target containers with the smallest fill openings. Limits are set for example by the particle—or grain size and the flow properties of the dosage material to be dispensed as well as by the configuration of the outlet opening and in particular the design of the closure element. Furthermore, the border area of the fill opening of the target container, for example the so-called ground joint surface, should as far as possible not be contaminated with dosage material as the fill opening will possibly have to be closed tight with a glass stopper after the filling has been completed.

It is therefore the object to provide a laboratory instrument with a dosage-dispensing device whereby the smallest quantities of powders, pastes or granulates can be measured out in precise doses into a target container with an opening of small cross-sectional area.

### SUMMARY

This objective is met by a laboratory instrument according to the accompanying claims.

A laboratory instrument includes at least one dosage-dispensing device whereby dosage material in the form of a powder, paste or granulate can be dispensed in measured doses into a target container. The dosage-dispensing device can be of a design like those described above and can for example include a source container and a dispensing head. The dispensing head has an outlet opening which is formed normally in the lowest part when the dispensing head is in its operating position and through which the dosage material in the source container can be delivered to the outside. The aperture cross-section of the outlet opening is normally varied by means of a dispensing head valve.

According to the disclosed embodiments, the laboratory instrument is equipped with at least one dosage material funneling device which is arranged so as to be mechanically independent of the dosage-dispensing device. Mechanically independent means that no direct mechanical connection exists between the dosage-dispensing device and the dosage material funneling device. For example, the dosage-dispensing device can be exchanged without the need to remove the dosage material funneling device. This further implies that the dosage material funneling device is not fastened to the dosage-dispensing device. This ensures that movements of the dosage material funneling device are not transmitted to the dosage-dispensing device. However, both the dosage material funneling device and the dosage-dispensing device are parts of the laboratory instrument, and therefore both devices are at least supported by the base of the laboratory instrument and therefore have an indirect mechanical connection to each other.

The dosage material funneling device is arranged between the outlet opening of the at least one dosage-dispensing device and the target container. Of course, the laboratory instrument can have several dosage-dispensing devices, and there can be a dosage material funneling device allocated to each dosage-dispensing device. The dosage material funneling device includes an agitating means and at least one funnel holder arranged on the agitating means. The funnel holder is configured as a holder for an exchangeable funnel which, when in operating position in the funnel holder, has a narrowing taper in the direction of gravity, so that dosage material leaving the outlet opening of the dosage-dispensing device is bundled into a narrow stream and directed into the opening of the target container. The funnel can only be connected to the at least one funnel holder. Together with the mechanical independence of the dosage material funneling device in relation to the dosage-dispensing device, this facilitates a quick exchange of the funnel.

The agitating means serves to set the funnel holder and the funnel seated in it into oscillating motion during the dosage delivery. The funnel is thereby subjected for example to a linear and/or rotary vibration or shaking movement which promotes the flow of the dosage material through the funnel and counteracts the accumulation of dosage material at the funnel wall or in the outlet orifice of the funnel. The linear oscillation, or the axis of rotation of the rotary oscillation, can be oriented horizontally, vertically or at any angle of inclination. Possible choices for the drive source of the vibration or shaking movement include for example a piezoelectric ultrasound generator or an eccentric mass driven by an electric motor.

As may be implied from the preceding description, the funnel in its operating state has to be solidly connected to the funnel holder with suitable fastener means, so that the movements of the agitating means can be transmitted to the funnel. With preference, clamping-, latching-, or snap-fastener systems are used which facilitate a quick exchange of the funnel. The funnel preferably has suitable projections on the outside which are matched to the fastener means and provide a form-locking connection with the fastener means.

The reason why it is important that the funnel can be exchanged quickly, independent of the dosage-dispensing device, is that any residues of dosage material can be discarded together with the funnel, so that they are not mixed into another dosage material in the next following dispensing process. The funnel is therefore preferably designed as a consumable article, made of a low-cost material, for example a polymer such as PTFE or polyethylene, or also of a ceramic material or a metal.

Furthermore, it is also possible in the middle of a dosage-dispensing process to remove dosage material that clogs up the funnel by interrupting the dispensing process, removing the clogged funnel and replacing it with a new funnel. With the new funnel the dosage-dispensing process can be resumed, in which case the quantity of dosage material which is already in the target container is registered as a first step in the continuation of the process, the remaining difference to the dosage target is calculated, and this remaining quantity is dispensed into the target container.

Residues of dosage material sticking to the funnel can further have an undesirable effect in the final phase of a dosage-dispensing process, as the dispensing head valve is controlled for example dependent on the increasing weight of the target container on the balance, and the residues of dosage material sticking to the funnel are therefore not registered. Particularly in dispensing the smallest quantities with high precision, this can have the consequence that the delivered quantity is not within the required bandwidth of the target quantity. The latter problem could be solved by using a further weighing cell to also continuously weigh the funnel during the dosage-dispensing process.

Of course, one could in addition also measure the weight of the dosage-dispensing device. Its mass decrease would have to be equal to the sum of the respective masses in the funnel and in the target container. This concept could serve to accurately register the loss of dosage material. Depending on the nature of the dosage material, for example in the case of toxic substances, this system could serve to warn the user.

The laboratory instrument is preferably equipped with a refill magazine for new funnels and with a disposal station for used funnels. This facilitates an easy exchange of funnels after each dispensing process, which is particularly important at those times when the dispensing head is exchanged and a different dosage material is to be dispensed.

In the embodiment of the laboratory instrument according to the foregoing description, it is of advantage if the funnel holder can be moved between at least three positions, where the first position matches up with the refill magazine, the second position with the dosage-dispensing device, and the third position with the disposal station. The shifting between the three positions can be realized for example by swiveling or rotating about an axis. Of course, linear displacements are also possible.

The funnel holder can further be equipped with an automatic drop-off device which is configured so that after the funnel holder has been moved into the third position, the funnel is automatically sent to the disposal station.

Especially with sticky and not free-flowing dosage materials, it is important that the funnel is observed during a dosage-dispensing device and that the dispensing process is stopped if two much material has accumulated in the funnel or if the funnel is even clogged up. As a means of automating this surveillance, the funnel holder can be equipped for example with an ultrasound sensor, an infrared sensor, a light gate sensor, or also with a weighing cell.

A further embodiment of the laboratory instrument additionally includes a first weighing cell with a load receiver for a target container, a second weighing cell to register the weight of the funnel, as well as a processor unit to process the weighing signals generated by the first and second weighing cells, which are used to control the delivery rate of the dosage-dispensing device.

In all disclosed embodiments, the funnel is advantageously configured as a conically tapered duct with a large entry cross-section and a small exit cross-section, with the angle between the funnel wall and the cone axis of the funnel being preferably no more than 10°. If the entry cross-section and the exit cross-section are prescribed, the steeper the funnel wall is sloped, the longer will be the funnel, but the smaller the danger that dosage material remains stuck in the funnel or is thrown in an upward direction by the vibrations.

Likewise for the purpose of preventing that dosage material is flung back by the vibrations and thrown over the rim of the funnel, there can be a barrier ring arranged in the entry area of the funnel. There can further be an end tube arranged at the outlet of the funnel. The tube can be considerably longer than the funnel, so that it can reach deep into the target container.

Of course, the funnel can have any desired cross-sectional profile. Preferably, this profile is adapted to the aperture cross-section of the target container and to the oscillation amplitude of the agitating means.

Furthermore, to reduce the tendency of dosage material to stick to the internal surface of the funnel, the internal surface can have a special surface finish or coating, for example a nanoparticle coating. Other possibilities to improve the gliding properties of the dosage material are based on the concept that the internal surface of the funnel carries special surface structures which are matched to the oscillations of the agitating means. For example, the inside of the funnel could have a surface structure similar to fish scales, wherein the dimensions of the individual scales are matched to the amplitude, the direction of movement, and the frequency of the agitating means, so that the oscillations and the structured surface cause accelerations in the dosage material in the peripheral area of the funnel only in the direction towards the target container, and that the gliding resistance of the surface is reduced.

In the dispensing of doses of powders, pastes or granulates into a target container with a laboratory instrument as described herein, it is advantageous to use a method with the following steps:

A funnel is set into the funnel holder;

The entry cross-section of the funnel is brought into alignment with the outlet opening of the dosage-dispensing device, and the target container is positioned so that its fill opening agrees with the outlet aperture of the funnel;

The delivery of dosage material from the dosage-dispensing device is started, while the agitating device is put into operation at the same time;

The delivery of dosage material from the dosage-dispensing device is continued until the dosage material received in the target container has reached a prescribed target quantity; and

After the dispensing process has been completed, the funnel is removed from the funnel holder.

With the version described above of a laboratory instrument as described, which in addition to the weighing cell for the target container has a second weighing cell to measure the weight of the funnel, it is advantageous to adapt the preceding method in the sense that the delivery of dosage material from the dosage-dispensing device is continued up to the point where the sum of the weights of the dosage material received by the target container and the dosage material still in the funnel has reached a prescribed target weight, and the funnel is subsequently still kept in motion, specifically in vibration, until the entire rest of the dosage material has been transferred as much as possible from the funnel into the target container. If there are still residues remaining in the funnel, so that the quantity of dosage material which has arrived in the target container does not quite equal the target weight, the difference may be evened out by dispensing additional material.

### BRIEF DESCRIPTION OF THE DRAWINGS

The laboratory instrument will be explained hereinafter in more detail through examples and by referring to the drawings, wherein:

FIG. 1 schematically illustrates a laboratory instrument in its operating state, with a dosage-dispensing device, a dosage material funneling device, and a target container;

FIG. 2 shows an expanded version of the FIG. 1 laboratory instrument, with a refill magazine for new funnels, a disposal station for used funnels, and a device for dropping off the used funnel;

FIG. 3 schematically illustrates the signal flow for controlling a dosage-dispensing process in a laboratory instrument;

FIG. 4 schematically illustrates a funnel with a barrier ring; and

FIG. 5 schematically illustrates an agitating device with several funnel holders acting on the same funnel.

### DETAILED DESCRIPTION

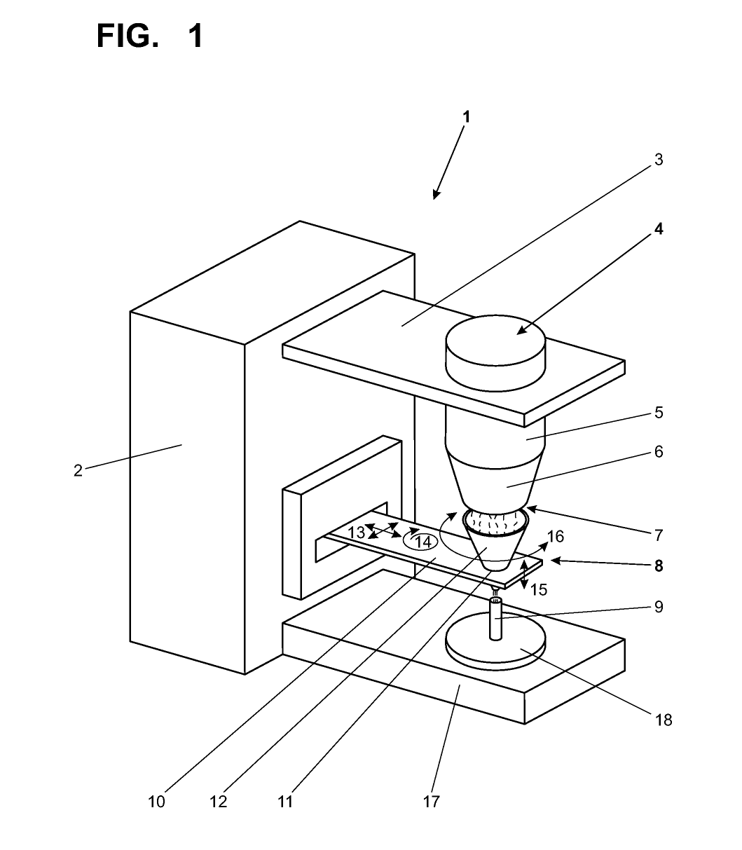

The laboratory instrument 1 of FIG. 1 includes a housing 2 with a carrier arm 3 in which an exchangeable dosage-dispensing device 4 is seated which, in turn, has a source container 5 for the dosage material and a dispensing head 6 with an outlet opening 7. The outlet opening 7 is not directly visible in the drawing. The laboratory instrument 1 and the dosage-dispensing device 4 are equipped with means that belong to the state of the art and are therefore not illustrated, whereby the schematically indicated outflow of dosage material from the outlet opening 7 can be controlled.

Arranged directly below the outlet opening 7 is the dosage material funneling device 8. The latter consists of an agitating means 10 in the form of a carrier with a funnel holder 11 which serves as a seat for an exchangeable funnel 12. By means of a conventional (and therefore not illustrated) motion generator, for example a piezoelectric vibrator or an electric motor with an eccentric mass, the agitating means 10 with the funnel 12 can be set into a vibration or shaking motion which counteracts the tendency of the dosage material to adhere to the funnel 12 and promotes an easy flow of the dosage material through the funnel 12. A variety of different possible movements of the agitating means 10 are indicated symbolically through arrows, for example, sideways and/or longitudinal oscillatory movements, represented symbolically by the crossed arrows 13, circular movements in a plane, represented symbolically by the circular arrow 14, vertical oscillatory movements, represented symbolically by the double arrow 15, or oscillatory movements of the funnel about its central lengthwise axis, represented symbolically by the circular double arrow 16.

Located directly below the outlet opening of the funnel 12 is the target container 9 which is positioned on the load receiver 18 of a first weighing cell 17.

As is illustrated in FIG. 1, the funnel 12 has the purpose of constricting the widely dispersed stream of dosage material flowing out of the outlet opening 7 of the dispensing head 6 and guiding it to the opening of the target container 9.

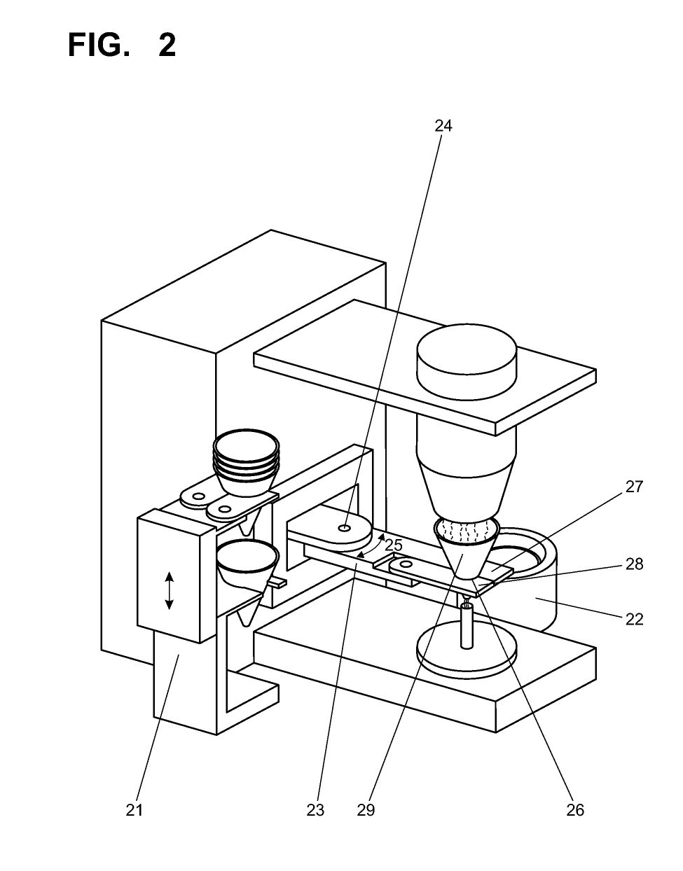

Expanding the arrangement shown in FIG. 1, the system that is schematically illustrated in FIG. 2 further includes a refill magazine 21 for new funnels 29 as well as a disposal station 22 for used funnels 29. The refill magazine 21 is designed so that it has a funnel-delivery position which is filled with a new funnel 29 from a funnel supply each time a funnel 29 has left the delivery position.

As indicated schematically by the circular double arrow 25, the agitating means 23 in the form of a carrier arm in FIG. 2 is pivoted on a bearing 24 so that it can swivel in a horizontal plane. The agitating means is further equipped with the capability to automatically drop off the funnel 29 into the disposal station 22 and to pick up a new funnel from the refill magazine 21, more specifically from the funnel delivery position. This function of the agitating means 23 is schematically indicated in FIG. 2 where the funnel holder 26 which holds the funnel 29 has an integral extension 27 of the agitating means 23 and a pivoted finger 28 which can swivel away from the extension 27. To drop off a used funnel 29, the agitating means 23 is swiveled over to the disposal station 22, the finger 28 is turned away from the extension 27, and the funnel drops into the disposal station 22. To pick up a new funnel 29, the agitating means 23 is swiveled over to the refill magazine 21.

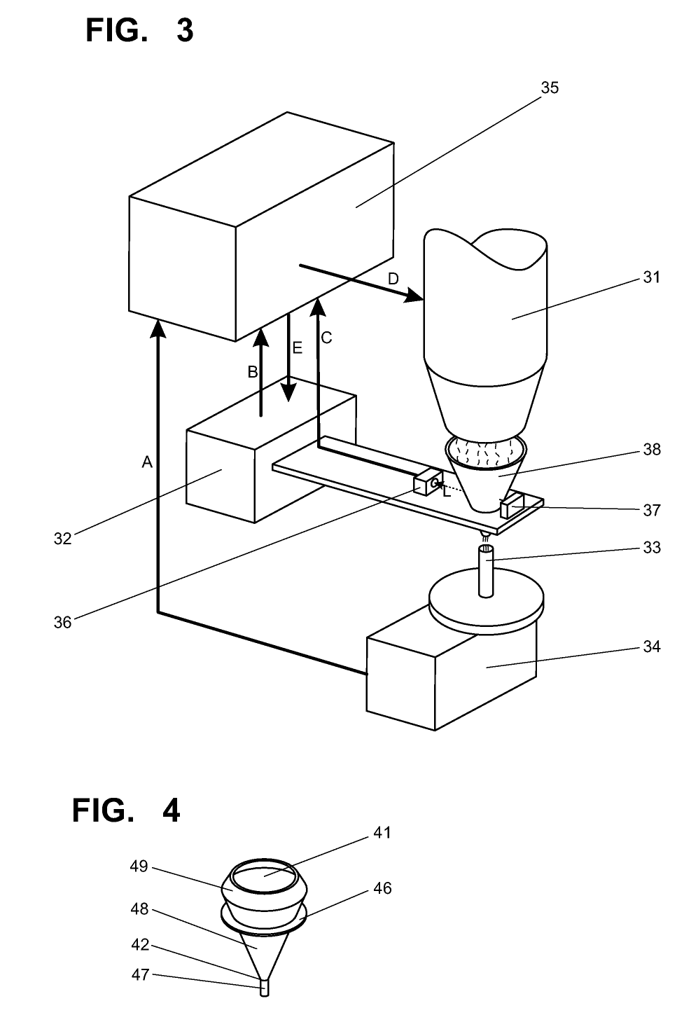

In a schematic representation FIG. 3 shows an example for the signal flow of the control—and regulating loops for the control of the dosage-dispensing device 31 and the dosage material funneling device 32. The weight of the target container 33, specifically the net weight of the dosage material contained in the target container, is continuously being transmitted from the weighing cell 34 to the processor unit 35, as indicated symbolically by the arrow A. The processor unit 35 further receives from the dosage material funneling device 32 the signal B which represents the weight of the dosage material which may be present in the funnel 38. A light gate 36, 37 functions as a safety turn-off switch for the dosage-dispensing device 31, wherein in order to realize this concept the funnel 38 consists of a transparent material. As long as dosage material flows freely through the funnel 38, the light sensor 36 receives the light beam L which is sent by the light source 37 through the lower part of the funnel 38. The light beam L as an analog signal contains two kinds of information. First, a decrease of the light intensity registered by the light sensor 36 indicates that dosage material is collecting on the funnel wall or in the funnel 38. Second, there is also the possibility to register and evaluate the flow density of the dosage material streaming through the funnel 38.

If the funnel begins to become clogged up for example if the dosage material is of a sticky consistency, the light beam L is blocked, and this is conveyed to the processor unit 35 through the signal C. Based on the incoming signals A, B, C, the processor unit 35 controls on the one hand the dosage-dispensing device 31 by way of the signal D and on the other hand the dosage material funneling device 32 by way of the Signal E. The signal D represents in this case the entire digital and/or analog information through which the starting and stopping and possibly also the variable delivery rate of the dosage-dispensing device 31 are controlled. The signal E serves to switch the vibration and or shaking movement on and off and possibly also to control the frequency and/or amplitude of the vibration or shaking movement which is imparted on the funnel 38 by the dosage material funneling device 32.

FIG. 4 shows a funnel 48 which is equipped with a barrier ring 49 in the area of the entry cross-section of the funnel. The barrier ring 49 prevents that as a result of the vibrations dosage material could move against the direction of gravity beyond the entry cross-section 41. In addition, there can be a cylindrical end tube 47 arranged at the exit cross-section 42 of the funnel 48, through which the dosage material can be channeled past the closure zone, for example past a conically ground internal surface area of a target container. Of course, the end tube 47 can be significantly longer than the length of the funnel 48. As an aid to setting the funnel 48 into a funnel holder for example by means of a robot, there can be holding and gripping features formed on the outside of the funnel. These are represented schematically in FIG. 4 as a collar 46. This collar 46 can also be gripped by the fastener means which are arranged on the funnel holder.

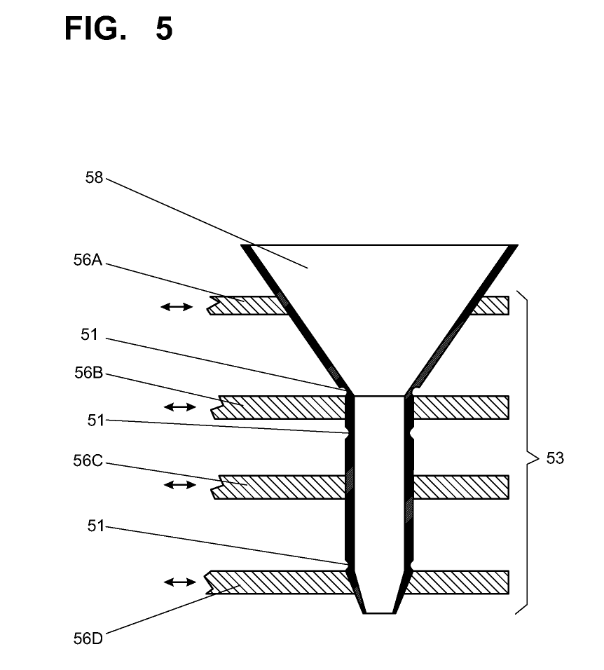

FIG. 5 schematically illustrates an agitating means 53 with several funnel holders 56A, 56B, 56C, 56D acting on the same funnel 58. The funnel holders 56A, 56B, 56C, 56D are arranged above each other, with the seating holes for the funnel 58 being aligned with each other so that a funnel can be set from above into the funnel holders 56A, 56B, 56C, 56D. As indicated by the double arrows, the funnel holders 56A, 56B, 56C, 56D are able to move individually relative to each other. It is therefore possible with a suitable mechanical or electrical control arrangement to generate any desired motion patterns, for example undulating movements propagating in the lengthwise direction of the funnel 58.

For these kinds of kinematic capabilities to serve a purpose, the funnel should preferably be made of a flexible material. Only in this way can the very low-amplitude movements be transferred to the individual sections of the cone 58. If stiffer materials are used, it is advantageous if the funnel is additionally provided with thinned-down transitions 51.

Although the invention has been presented though specific examples of embodiments, there are obviously numerous further variations that could be created from a knowledge of the present invention, for example by combining the features of the individual embodiments with each other and/or by exchanging individual functional units of the embodiments against each other. In particular, there are further embodiments conceivable in which the subject of the invention could be incorporated, for example if the laboratory instrument in an automated version is used as a component of a larger system.

What is claimed is:

1. A laboratory instrument for dispensing a material in a powder, paste, or granular form into a target container, comprising:
a dosage-dispensing device, having an outlet opening; and
a dosage material funneling device, disposed between the outlet opening and the target container, and arranged to be mechanically independent of the dosage-dispensing device, the dosage material funneling device comprising:
a means for agitating;
a funnel; and
a funnel holder, arranged on the agitating means, such that the funnel can be connected exclusively to the funnel holder with a width of the funnel decreasing in the direction of gravity when the laboratory instrument is in an operating position.

2. The instrument of claim 1, further comprising:
a refill magazine for unused funnels; and
a disposal station for used funnels.

3. The instrument of claim 2, wherein:
the funnel holder is configured with the capability to swivel or rotate about an axis between at least three positions, such that the refill magazine is operatively engaged in the first position, the dosage-dispensing device is operatively engaged in the second position and the disposal station is operatively engaged in the third position.

4. The instrument of claim 1, wherein:
the funnel holder comprises an automatic drop-off device.

5. The instrument of claim 3, wherein:
the funnel holder comprises a means for measuring and monitoring a fill level of the dosage material that accumulates in the funnel during operation.

6. The instrument of claim 3, wherein:
the agitating means generates shaking movements, vibrations or ultrasonic oscillations in a linear, circular or rotary mode about a central lengthwise axis of the funnel, which movements are imparted to the funnel.

7. The instrument of claim 3, further comprising:
a first weighing cell with a load receiver for a target container;
a second weighing cell, connected to the dosage material funneling device for measuring the weight of the funnel, and
a processor unit for processing the weighing signals generated by the respective weighing cells to control the delivery rate of the dosage-dispensing device.

8. The instrument of claim 1, wherein:
the funnel holder comprises a means for measuring and monitoring a fill level of the dosage material that accumulates in the funnel during operation.

9. The instrument of claim 1, wherein:
the agitating means generates shaking movements, vibrations or ultrasonic oscillations in a linear, circular or rotary mode about a central lengthwise axis of the funnel, which movements are imparted to the funnel.

10. The instrument of claim 1, further comprising:
a first weighing cell with a load receiver for a target container;
a second weighing cell, connected to the dosage material funneling device for measuring the weight of the funnel, and
a processor unit for processing the weighing signals generated by the respective weighing cells to control the delivery rate of the dosage-dispensing device.

11. A funnel, for use with a funnel holder of the laboratory instrument of claim 1, comprising:
a tubular shape, with a large entry cross-section and a small exit cross-section; and
an angle between a wall of the funnel wall and a central lengthwise axis of the funnel being less than or equal to 10°.

12. The funnel of claim 11, further comprising:
at least one of:
a barrier ring arranged in the area of the entry cross-section; and
a cylindrical end tube arranged at the exit cross-section.

13. The funnel of claim 12, further comprising:
an internal surface with at least one of:
a surface finish that reduces the tendency of dosage material to stick thereto; and
a surface structure that is matched to the movements of the agitating means.

14. The funnel of claim 11, further comprising:
an internal surface with at least one of:
a surface finish that reduces the tendency of dosage material to stick thereto; and
a surface structure that is matched to the movements of the agitating means.

15. A method for dispensing a material in a powder, paste or granular form into a target container in a measured dose, using the laboratory instrument of claim 1, comprising the steps of:
connecting a funnel of claim 11 to the funnel holder of the instrument;
aligning the entry cross-section of the connected funnel with the outlet opening of the dosage-dispensing device and aligning the exit cross-section of the funnel with the fill opening of the target container;
activating the agitating means and the dosage-dispensing device so that the measured dose is delivered into the entry-cross-section of the aligned and connected funnel from the dosage-dispensing device; and
removing the funnel from the funnel holder after the measured dosage has been delivered therethrough to the target container.

16. A method for dispensing a material in a powder, paste or granular form into a target container in a measured dose, using the laboratory instrument of claim 10, comprising the steps of:
connecting a funnel of claim 11 to the funnel holder of the instrument;
aligning the entry cross-section of the connected funnel with the outlet opening of the dosage-dispensing device and aligning the exit cross-section of the funnel with the fill opening of the target container;
activating the agitating means and the dosage-dispensing device so that the measured dose is delivered into the entry-cross-section of the aligned and connected funnel from the dosage-dispensing device; the delivery from the dosage-dispending device occurring until the weight of the material delivered to the target container and the weight of the material remaining in the funnel total a predetermined target weight of the dose, with the agitating means remaining activated as long as material continues to transfer from the funnel into the target container;
reactivating the dosage-dispensing device as necessary until the predetermined target weight of the material has been transferred to the target container; and
removing the funnel from the funnel holder after a dosage has been delivered therethrough to the target container.
